(19) United States
(12) Patent Application Publication
(10) Pub. No.: US 2003/0158673 A1
(43) Pub. Date: Aug. 21, 2003

(54) Method for creating a blood bank with associated data bank

(75) Inventors: Richard Grosse, Berlin (DE); Hans-Joachim Rodger, Berlin (DE); Wolfgang Gerhard, Berlin (DE); Robert Grosse, Berlin (DE)

Correspondence Address: FRIEDRICH KUEFFNER, P.C., SUITE 910, 317 MADISON AVENUE, NEW YORK, NY, 10017, US

(73) Assignee: InGene Institut fur genetische Medizin GmbH

(21) Appl. No.: 10/279,750

(22) Filed: Oct. 24, 2002

(30) Foreign Application Priority Data
Feb. 16, 2002 (DE) 102 06 482.2

(51) Int. Cl. G06F 19/00

(52) U.S. Cl. 702/19

(57) ABSTRACT

The present invention relates to a method for creating a blood bank in which blood samples are preserved and the values determined from the blood samples can be linked via suitable algorithms to a data bank in which clinical data and specialized medical knowledge are stored.

The present invention relates to a method for creating a blood bank with associated data bank.

The conventional methods for identifying genes which could be of relevance for research purposes and for development of new drugs involved searching through gene data banks for genes which, according to existing knowledge, are connected with specific diseases or functions. That is to say the operator of the gene data bank provides genes with specific attributes. As soon as specific attributes are called up, the result is that all genes provided with these attributes are named. This method has the disadvantage that a large number of genes are often identified which, in addition to the relevant attributes, are associated with additional functions which are not required for the concrete research purpose. Only in the subsequent research work on the genes is it established whether the gene is actually of use. A disadvantage is that this type of gene identification is lengthy and associated with high costs, and it is possible that an initially identified gene will in the end prove to be of no use.

Other data banks specialize only in certain diseases, for example asthma, heart disease, and depression. The input data cannot be compared within various clinical data banks, i.e. horizontally within different diseases. For this reason, general correlations cannot be determined. The existing data cannot easily be transferred to other clinical pictures. The scope of use is thus limited, particularly with respect to the polyfactorial (polygenic) diseases which are of importance in terms of health policy and economics.

A further disadvantage of previous gene-based research into diseases lies in the fact that targeted gene analysis is undertaken only periodically after a specific diagnosis has been made in larger patient groups. The research is limited to standard laboratory procedures and at best includes the familial history of the disease within the scope of the research. Other important factors which may be at the origin of a disease, for example individual lifestyle or environmental influences, are not taken into consideration. An additional disadvantage is that there has not in the past been sufficient linking of known clinical facts and gene functions.

The linking of features which were assigned to a phenotypical grouping is of particular relevance here, especially also in the conduct of association studies for identifying genes associated with diseases.

A phenotype in this sense is the entirety of the features of an individual which are made up by the effect of his hereditary factors in combination with the influences of his environment. They are both of a functional type and a structural type. However, a phenotype can also be considered as the formation of a quite specific feature, related to the action of a gene causing this feature. Since genetic and environmental influences to a large extent supplement each other and overlap, the determination and analysis of the interaction of these influences is of particular importance for research into diseases. A structured collation of genetic data and information on environmental influences with subsequent linking and analysis has in the past been neglected in research. There is no standardized recording of all clinical phenotypical features in the form of a data bank and no corresponding screening tools.

A further disadvantage of the previous research is that it is in each case limited to just one individual specific gene whose function and area of use are investigated. However, many diseases are caused by a number of genes and are crucially linked with the interaction of external influences. This interaction is not taken into consideration in conventional research.

The aforementioned data banks and conventional research methods are therefore generally associated with the disadvantage that only parts of the overall picture are taken into consideration when seeking to identify genes linked to diseases and to carry out research into drugs. Another disadvantage of the previous creation of gene data banks is that only the analyzed DNA is preserved.

The object of the present invention is therefore to create a blood sample bank of the aforementioned type with which it is possible to identify, from the blood sample bank, a DNA sample, a serum sample or a plasma sample or a gene whose function correlates with phenotypical features of a patient.

This object is achieved by the fact that blood samples are preserved, separated as buffy coats and serum, and the values determined from the blood samples are linked via suitable algorithms to a data bank in which clinical data, environmental data, the lifestyle circumstances of a patient and specialized medical knowledge are stored.

To carry out the method according to the invention, blood samples are collected, preferably from persons (patients) in a pathological state. The blood samples are collected and subsequently processed preferably in accordance with the guidelines on obtaining blood and blood constituents and on using blood products as are described in the German Federal Health Gazette (published in German Federal Health Gazette 2000; 43:555-589).

To carry out the method according to the invention, two blood samples are collected in each case, preferably from persons in a pathological state.

Lymphocytes and blood plasma are collected from the first sample. To prevent clotting of the sample, citrate buffer, EDTA buffer, oxalate buffer, heparin, stabilizer solutions or other anticoagulants are added to the withdrawn blood sample. Citrate buffer is preferably added to give citrated blood in order to prepare the plasma and buffy coats.

e.g.

ACD-A Solution (BectonDickinson) Citrate Phosphate Dextrose

100 ml of ACD (ph 5.05) contain:

| | | |
|---|---|---|
| Citric acid | 0.73 | g |
| Sodium citrate | 2.2 | g |
| Glucose | 2.45 | g |

Water for injection ad 100 ml

1:5.67 addition: blood

Citrate Monovette (Sarstedt):

0.106 M trisodium citrate according to ISO 6710 for coagulation analysis

1:9 addition blood

For separation into plasma, erythrocytes and buffy coats, the pretreated samples are centrifuged. The layer of leukocytes (white blood cells subdivided into granulocytes, lymphocytes, monocytes) and thrombocytes (blood platelets) between plasma and erythrocytes is designated as “buffy coats”.

From this first blood sample, preferably 2-20 ml, particularly preferably 8-12 ml, 40-60% is preferably isolated as plasma and 10-20% as buffy coat. The blood plasma is frozen and stored at a temperature of between −18° C. and −80° C. The buffy coats are cryopreserved in liquid nitrogen.

The further treatment of the buffy coats which is described below can be carried out before or after the cryopreservation.

By means of a density gradient centrifugation, for example with Ficoll or Percoll, the lymphocytes from the buffy coats can be separated from any impurities still remaining. Lymphocytes are the only blood cells that can be kept in culture over several stages of separation. For this purpose, they are taken up after purification in culture medium, for example HAM F12, RPMI 1640 or the like, and are stimulated by means of mitogens, for example phytohemagglutinin or phorbol 12-myristate 13-acetate.

The lymphocytes are transformed so that they are able to continue growing as immortalized cells in culture. The lymphocytes are preferably transformed with the Epstein-Barr virus (EBV). EBV is a human-pathogenic herpesvirus which is a causative agent of mononucleosis, Burkitt's lymphoma and nasopharyngeal carcinoma. The virus can immortalize human lymphocytes.

To obtain an immortalized lymphocyte cell line, however, some of the abovementioned steps, for example the density gradient centrifugation or stimulation, can be omitted.

The cells can be cryopreserved after one of the abovementioned steps. In other words, lymphocytes are frozen. The cells are preferably stored in culture medium and with addition of protective substances, for example glycerol and DMSO (dimethyl sulfoxide), at −196° C. in liquid nitrogen. Thawed cells can also be further used according to the treatment described above.

The transformed lymphocytes have the advantage that they can be cultured. This permits unlimited multiplication of the cells and unlimited DNA analyses.

Parallel to the preparation of citrated blood, serum is obtained from the second blood sample of 2-20 ml, preferably 8-12 ml, particularly preferably 10 ml. The isolated serum is frozen and stored at a temperature of between −18 and −80° C.

Blood plasma, blood serum and buffy coats or lymphocytes from each patient, as carriers of the genetic information, are therefore stored in the blood bank according to the invention.

The advantage lies in the fact that the blood samples do not have to be fully analyzed immediately after withdrawal and, accordingly, the results of these analyses do not have to be immediately evaluated and cataloged. In particular, it is not necessary, for each patient who submits a blood sample, to initially purify DNA expensively which then has to be stored in a DNA data bank. By storing lymphocytes and transforming them, DNA and thus the genetic information is available in unlimited quantities.

It is also of advantage to store the patients' cells and not just the DNA, since the analysis methods can then always be carried out in accordance with the most recent state of the art. In addition, initial (gene) therapy experiments can thus be carried out directly with the cells from the pathological patients.

In the present method according to the invention, the buffy coats which appear to be possibly relevant after the data comparison, or the cell lines obtained from these, are used from patients of similar phenotype (cluster or group of features). In this way, the work involved in purifying the DNA is minimized to patients belonging to one “phenotype”.

The blood samples are recorded. These data are then input into a computerized system. When storing the data, all the relevant data protection regulations are of course complied with, and all the data are stored only in anonymous format and/or are secured cryptographically. The data are encoded using a coding procedure and are forwarded in coded format into a data bank. Encoding of the data is advantageous in order to guarantee the anonymity of the personal data and to prevent the users of the data bank being able to attribute a blood sample to a patient.

The data bank is also protected against unauthorized access by the usual technical means, for example restricted authorization, PIN or firewall.

According to the invention, the data bank consists of information input modules, with three input modules preferably being used. Input modules within the context of the invention are fixed and for the most part standardized categories of data or information. The input modules are preferably made up of the categories of “clinical data”, “specialized knowledge” and “DNA analyses”.

The “clinical data” input module concerns clinical data of persons who are preferably in a pathological state and are being treated medically.

Data from the patients are also determined using formulated questionnaires which contain standardized questions and answers. According to the invention, there are two types of questionnaires. One questionnaire is first given to the patient and is to be completed by the latter. This questionnaire contains questions on phenotypes, preferably case history, anthropometry and family, and in addition questions on individual lifestyle and on individual environmental influences.

The other questionnaire is to be completed by the physician. This questionnaire is divided into two sections, namely a general part and a specialized part. The general part contains questions on general medical fields and general symptoms which are characterized by the fact that they often occur in pathological manifestations and possibly have a genetic cause.

An advantage of this general part of the questionnaire is that the questions are not limited to a specific clinical picture but instead are of a more general medical nature. The data thus determined can be compared independently of the specific clinical picture, in other words across diseases, in order to elucidate relationships between different diseases.

The specific part contains questions on clinical phenotype which are related to a specialized medical field. These specialized fields are preferably cardiology, gastroenterology, pulmonology, nephrology, oncology, endocrinology, rheumatology, allergology, urology, gynecology and pediatrics.

It is an advantage that this questionnaire combines answers which cover the usual specialized medical fields and the associated typical diseases with their phenotypical features, syndromes and diagnoses. One questionnaire can be used for each specialized medical field. The questionnaires for the different specialized fields differ only in the specific part.

All persons making their clinical data available are registered by means of suitable software. To ensure that the individual patient data cannot be identified as belonging to one specific patient, the patient data which were determined on the basis of the questionnaires are given a first pseudonym which is stored in the recording computer. The clinical data are then scanned into a computer and recorded by means of special software. After this procedure, the data are encoded.

The process for inputting the questionnaire data into the data bank system involves each answer from the questionnaire being converted into a code. This is preferably what is known as the UMLS standard code (Unified Medical Language System), each standard code containing over a dozen medical metathesauruses. Each metathesaurus in turn defines an aspect of a disease, of a disease pattern or of a symptom, or biological peculiarities of a disease.

The advantage of the UMLS lies in the fact that it automatically calls up a semantic network of medical data. As soon as a feature is encoded and input into the data bank system, it is classified according to UMLS. As soon as such a classification as a part or aspect of a specific disease is effected by the system, links are established to this disease, other diseases or other symptoms. The aim of this procedure is to elucidate a relationship between one individual phenotypical feature and a disease. It can also be used to complete a known clinical picture. Moreover, the input feature is assigned to a phenotypical grouping.

The success of this procedure is based on the fact that it is not just clinical data which are included in the disease analysis. According to the invention, the entirety of all the collated data of a phenotypical group obtained from the comparison of clinical data, genetic data, environmental data and actual lifestyle, is included in the data comparison. Each person providing clinical data is assigned to a specific phenotypical group.

A further input module can be the field of specialized knowledge. In this input module, all known clinical pictures and phenotypical features of a disease, as based on existing knowledge, are converted into a uniform computer language, forwarded into a computer data bank, encoded, and forwarded to the data bank.

According to the invention, clinical data and specialized knowledge are preferably converted into a uniform computer language in the data bank.

These data can be compared with one another by algorithmic linking. This can preferably be done with the aim of determining new phenotypical groupings (cluster analysis method).

Phenotypical analysis means that concrete clinical data are compared with the known specialized knowledge and involves grouping of the patient data. As many data items as possible must be collated, preferably more than 10,000, in order to permit a representative phenotypical grouping of each diseased person. The personal data and blood samples should be obtained from as many different population groups as possible, preferably from throughout Europe and Asia, and entered separately into the serum bank and data bank.

The groupings can be divided into subgroupings in order to improve the analysis of syndromes.

The comparison of concrete clinical data and known specialized knowledge according to the invention has the advantage that detailed phenotypical groupings can be determined. These phenotypical groupings can in turn be associated with the recorded blood samples by algorithmic linking. Genes associated with diseases can preferably be determined by means of this linking of phenotypical groupings with blood samples and genome data banks. However, a link can also be made with other blood banks or with generally accessible human genome data banks.

The data bank according to the invention is configured in such a way that it offers different application possibilities, preferably the determination of DNA and genes related to phenotypical groupings.

However, it is also possible to determine patient data with specific disease features, to use the data bank for research into new diseases, to determine side effects of drugs, to stratify clinical studies, or to establish new phenotypical groupings for therapeutic and diagnostic purposes.

The invention thus provides a completely new way of searching for relevant genes and for developing new drugs.

The present invention is described in more detail below with reference to the figures.

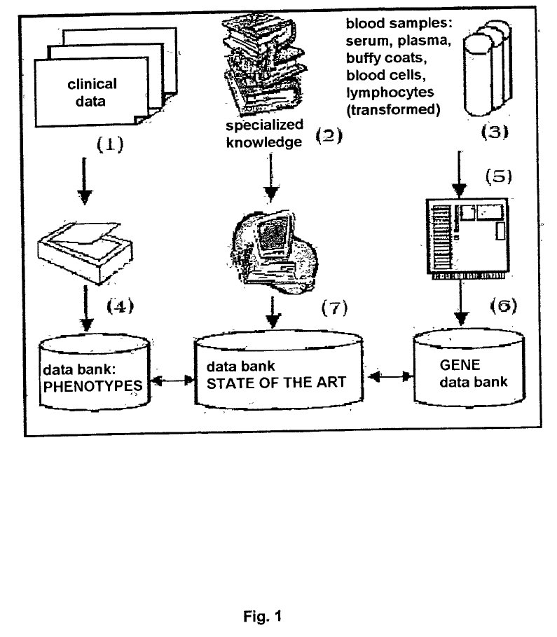

FIG. 1 shows an illustration of the input modules and of their interaction.

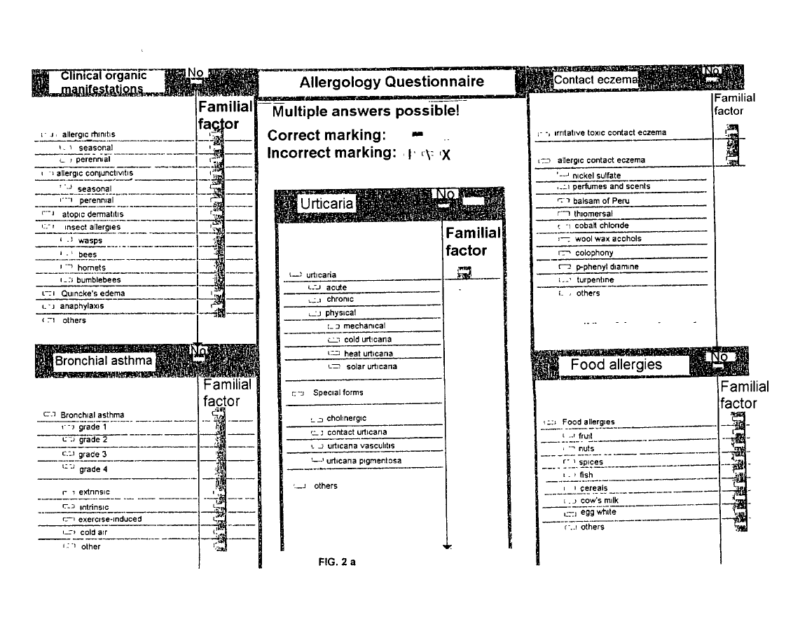

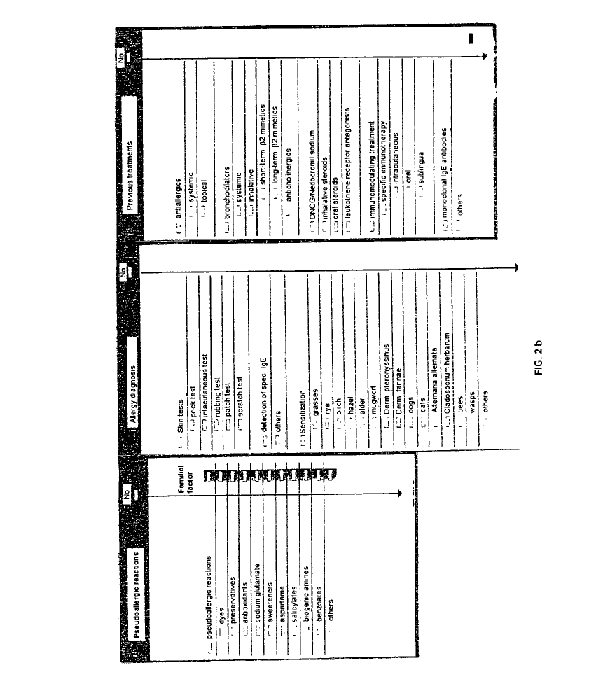

FIG. 2 shows an example of a physician's questionnaire, for example for allergology.

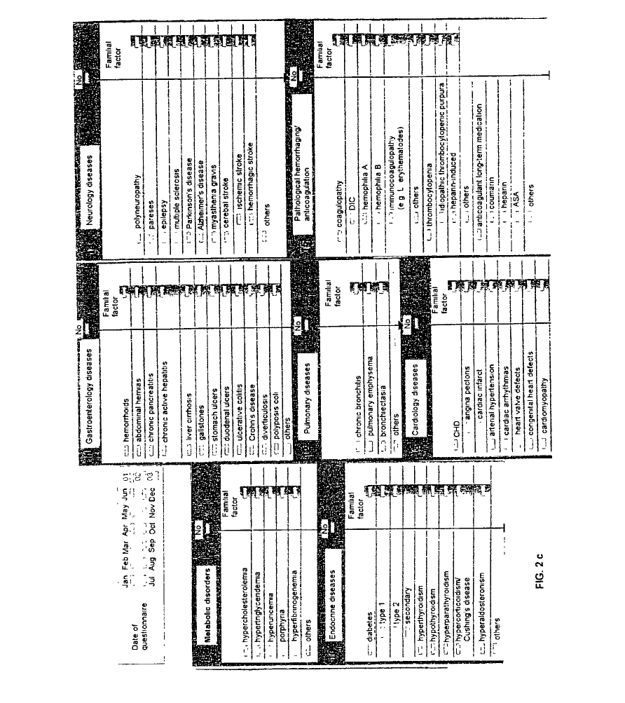

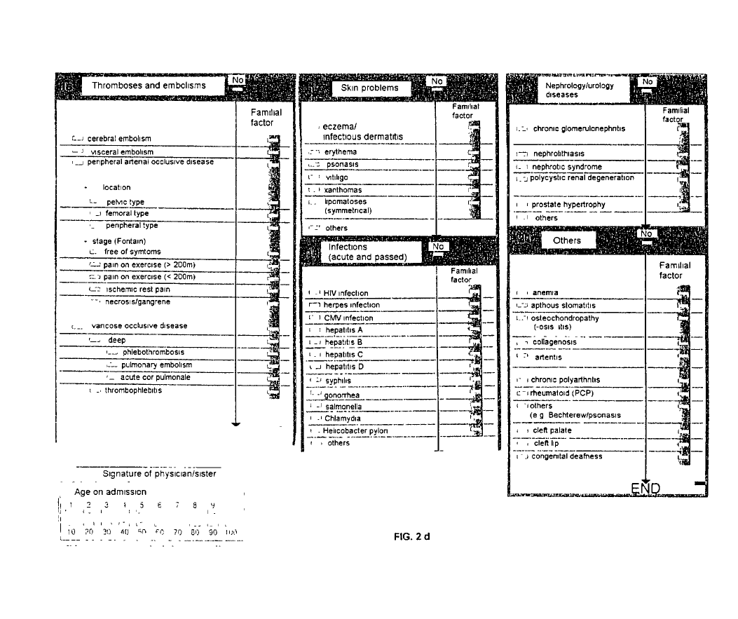

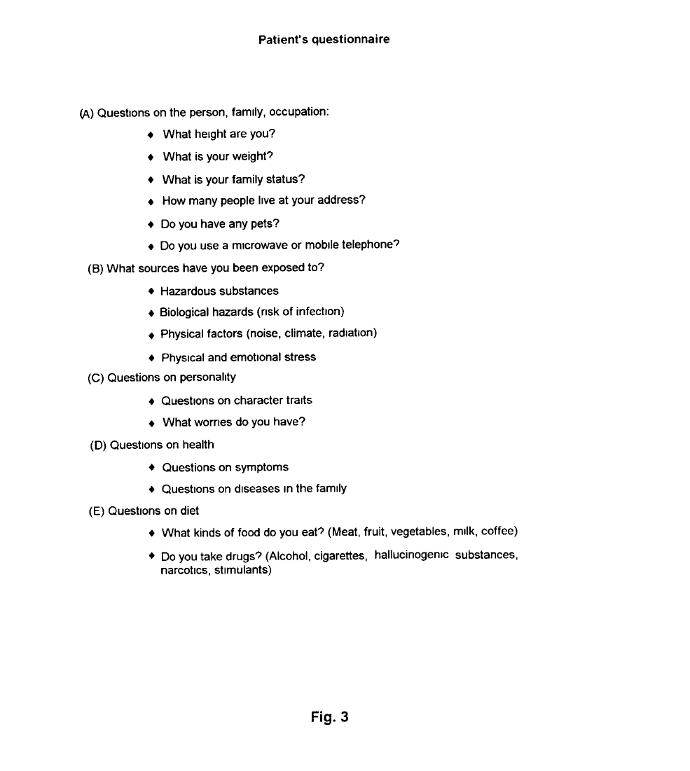

FIG. 3 shows examples of fields and questions in a patient's questionnaire.

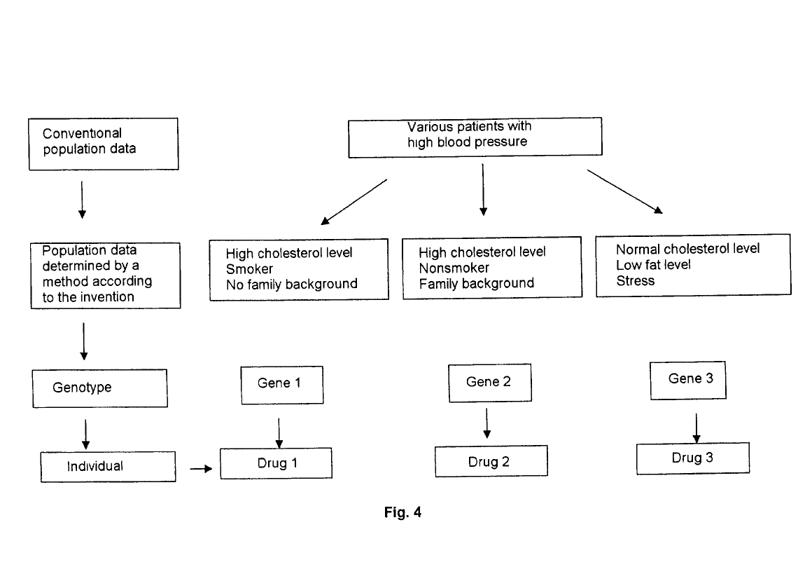

FIG. 4 shows an example of gene analysis on the basis of the method according to the invention.

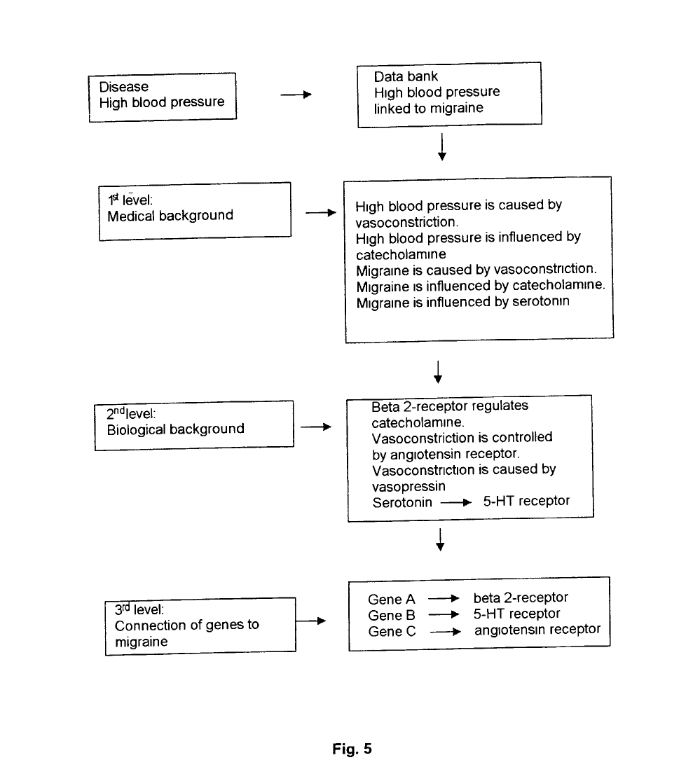

FIG. 5 shows an illustration of the linking procedure.

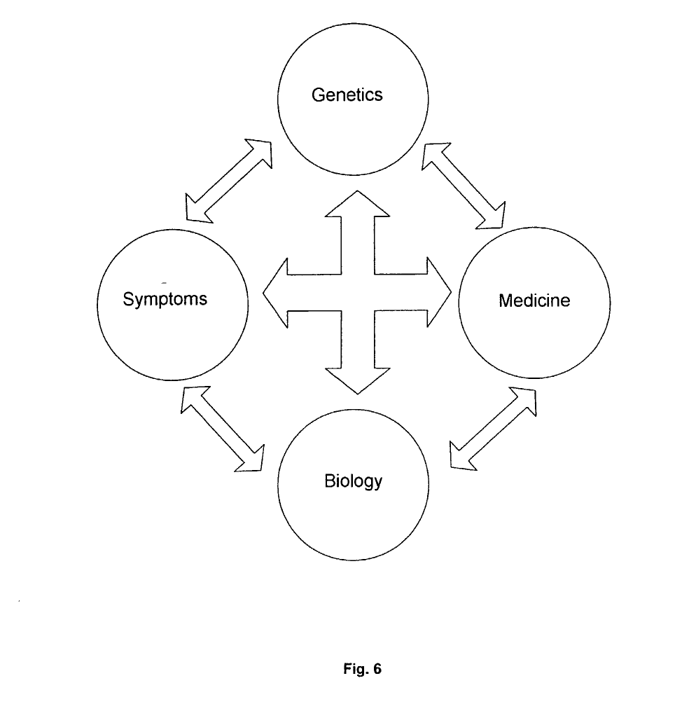

FIG. 6 shows a flow chart on the technology of the data collection and of the method sequence according to the invention.

Three input modules are shown in FIG. 1. These cover clinical data 1, specialized knowledge 2 and DNA analyses 3. The clinical data 1 are compared with the phenotypical patient data 4. The results of the blood sample analyses 3 are input in the memory 5 and the genome data bank 6. The phenotypical patient data and the genome data 5 are compared with the data 7. These data consist of specialized knowledge 2 and represent the state of the art.

The design of the questionnaire to be completed by the physician can be seen from FIG. 2. One questionnaire relates, for example, to the specialized field of cardiology. This in the first instance contains a list of questions related to cardiology diseases, for example arterial hypertension, ECG, invasive diagnosis of cardiac insufficiency, etc. The questionnaire also contains statements on other diseases, for example metabolic disorders, thromboses and skin problems. Further questionnaires can be created for all specialized areas. Examples of these are questionnaires for the fields of gastroenterology, pulmonology, nephrology, rheumatology, gynecology, pediatrics, urology, allergology.

FIG. 3 shows a questionnaire which is to be completed by the diseased person. This questionnaire is divided into questions on the individual, his or her family and occupation, questions on personality, general questions on health, questions on diet, and other questions.

FIG. 4 shows an example of gene analysis by the procedure according to the invention. Group 1 includes the features of high blood pressure, high cholesterol level, smoker, no familial predisposition. In addition, a group 2 is determined which includes, in addition to the feature of “high blood pressure”, the features of “high cholesterol level”, “nonsmoker”, but “familial predisposition”. Group 3 includes, for example, the features of “high blood pressure”, “normal cholesterol levels”, “fat-reduced diet” and “stress”. In the next phase, the relevant gene is determined by connecting the phenotypical groupings to the DNA data bank.

FIG. 5 shows how gene analysis can take place using the data bank according to the invention.

High blood pressure is cited as an example of a disease. With the data bank according to the invention, the term “high blood pressure” can now be connected to the term “migraine”. In the first step, these entries are compared with the specialized knowledge data bank. The result established is, for example, that high blood pressure is influenced by biogenic compounds such as catecholamines. Migraine is caused or influenced, for example, by vascular narrowing (vasoconstriction) or by compounds such as catecholamines and serotonin.

In the second step, under the heading “Specialized knowledge”, the biological background is investigated. This reveals various receptors which are relevant as causing or influencing the disease.

At the third level, the results are compared with the present genes. The result is, for example, that three genes are identified which are provided with the aforementioned receptors. In this way, known genes can be brought into connection with new disease symptoms. The results can thus be used for targeted drug development.

On the basis of the genes thus determined, drug research can be accordingly oriented to the requirements of the phenotypical groupings.

FIG. 6 shows the link between the individual areas in an analysis using the data bank according to the invention. Accordingly, it is not only a gene analysis in accordance with FIG. 5 that is possible. Rather, the data bank according to the invention permits access at each subsidiary area. By means of data comparison, correlations with the 3 remaining subsidiary areas are then established.

1. A method for creating a blood bank in which blood samples are preserved and the values determined from the blood samples can be linked via suitable algorithms to a data bank in which clinical data and specialized medical knowledge are stored.

2. The method as claimed in claim 1, wherein buffy coats, blood plasma and/or blood serum are isolated from the blood samples.

3. The method as claimed in claims 1 and 2, wherein lymphocytes are isolated from the buffy coats.

4. The method as claimed in one of claims 1 through 3, wherein the lymphocytes are transformed.

5. The method as claimed in one of claims 1 through 4, wherein the blood cells are transformed for culturing with the Epstein-Barr virus.

6. The method as claimed in one of claims 1 through 5, wherein the lymphocytes are cultured for creating the DNA analysis.

7. The method as claimed in claims 1 through 6, wherein 2 ml to 40 ml of blood are used for the analysis.

8. The method as claimed in claims 1 through 7, wherein the analysis data for the blood samples, serum and blood plasma and the DNA analysis results are recorded and input into a computerized system.

9. The method as claimed in claim 8, wherein the recorded data are compared via algorithms with the patient's clinical data and with the stored specialized medical knowledge.

10. The method as claimed in claim 9, wherein data from at least the fields of medicine, genetics, biology and symptoms are compared in the data comparison.

11. The method as claimed in claim 10, wherein, by means of data comparison when inputting data from one field, correlations with data from the other fields become clear.
